(19) United States
(12) Patent Application Publication
(10) Pub. No.: US 2024/0014875 A1
(43) Pub. Date: Jan. 11, 2024

(54) MULTI-PART BEAM REPORTING FOR MPE

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/035,252

(22) PCT Filed: Jan. 14, 2021
(86) PCT No.: PCT/CN2021/071686

§ 371 Date: May 3, 2023

(51) Int. Cl. H04B 7/06

(52) U.S. Cl. CPC H04B 7/0632; H04B 7/0639; H04B 7/0695

(57) ABSTRACT

The present disclosure relates to methods and devices for wireless communication of an apparatus, e.g., a UE and/or a base station. In one aspect, the apparatus may detect at least one maximum permissible exposure (MPE) event for at least one of one or more uplink beams, one or more downlink beams, or one or more UE panels. The apparatus may also configure, upon detecting the at least one MPE event, a channel state information (CSI) report including at least one part associated with the MPE event, the at least one part indicating at least one of the one or more uplink beams, the one or more downlink beams, or the one or more UE panels. The apparatus may also transmit, to a base station, the CSI report including the at least one part associated with the MPE event.

### BACKGROUND

### Technical Field

The present disclosure relates generally to communication systems, and more particularly, to MPE reporting in wireless communication systems.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). In some aspects, the apparatus may transmit, to a base station, one or more uplink beams or receive, from the base station, one or more downlink beams, where at least one maximum permissible exposure (MPE) event is detected for the one or more uplink beams or the one or more downlink beams. The apparatus may also detect at least one MPE event for at least one of one or more uplink beams, one or more downlink beams, or one or more UE panels. Additionally, the apparatus may configure, upon detecting the at least one MPE event, a channel state information (CSI) report including at least one part associated with the MPE event, the at least one part indicating at least one of the one or more uplink beams, the one or more downlink beams, or the one or more UE panels. The apparatus may also transmit, to a base station, the CSI report including the at least one part associated with the MPE event.

In an aspect of the disclosure, a method, a computer-readable medium, and an apparatus are provided. The apparatus may be a base station. In some aspects, the apparatus may transmit, to a user equipment (UE), one or more downlink beams or receive, from the UE, one or more uplink beams. The apparatus may also receive, from the UE, a channel state information (CSI) report including at least one part associated with a maximum permissible exposure (MPE) event, the at least one part indicating at least one of the one or more uplink beams, the one or more downlink beams, or one or more UE panels.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating example communication between a UE and a base station.

FIG. 4B is a diagram illustrating example communication between a UE and a base station.

FIG. 4C is a diagram illustrating example communication between a UE and a base station.

FIG. 5A is a diagram illustrating example information in a CSI report for wireless communication.

FIG. 5B is a diagram illustrating example information in a CSI report for wireless communication.

FIG. 6A is a diagram illustrating example information in a CSI report for wireless communication.

FIG. 6B is a diagram illustrating example information in a CSI report for wireless communication.

FIG. 7 is a diagram illustrating example communication between a UE and a base station.

FIG. 8 is a flowchart of a method of wireless communication.

FIG. 9 is a flowchart of a method of wireless communication.

FIG. 10 is a diagram illustrating an example of a hardware implementation for an example apparatus.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

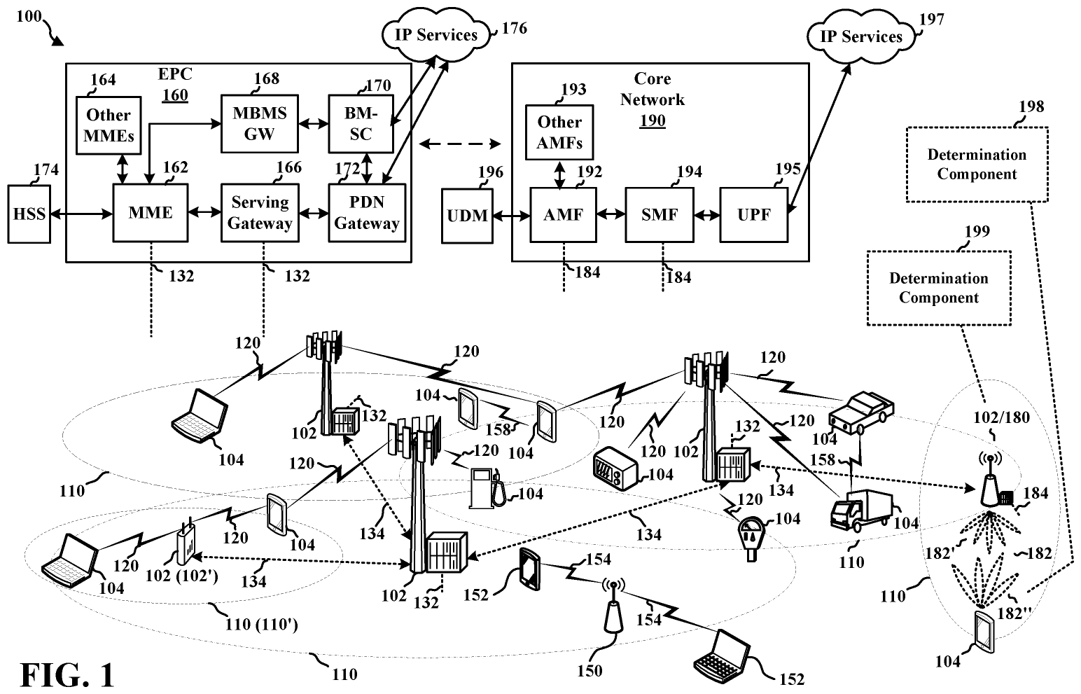

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/ UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a determination component 198 configured to transmit, to a base station, one or more uplink beams or receive, from the base station, one or more downlink beams, where at least one maximum permissible exposure (MPE) event is detected for the one or more uplink beams or the one or more downlink beams. Determination component 198 may also be configured to detect at least one MPE event for at least one of one or more uplink beams, one or more downlink beams, or one or more UE panels. Determination component 198 may also be configured to configure, upon detecting the at least one MPE event, a channel state information (CSI) report including at least one part associated with the MPE event, the at least one part indicating at least one of the one or more uplink beams, the one or more downlink beams, or the one or more UE panels. Determination component 198 may also be configured to transmit, to a base station, the CSI report including the at least one part associated with the MPE event.

Referring again to FIG. 1, in certain aspects, the base station 180 may include a determination component 199 configured to transmit, to a user equipment (UE), one or more downlink beams or receive, from the UE, one or more uplink beams. Determination component 199 may also be configured to receive, from the UE, a channel state information (CSI) report including at least one part associated with a maximum permissible exposure (MPE) event, the at least one part indicating at least one of the one or more uplink beams, the one or more downlink beams, or one or more UE panels.

Although the following description may be focused on 5G NR, the concepts described herein may be applicable to other similar areas, such as LTE, LTE-A, CDMA, GSM, and other wireless technologies.

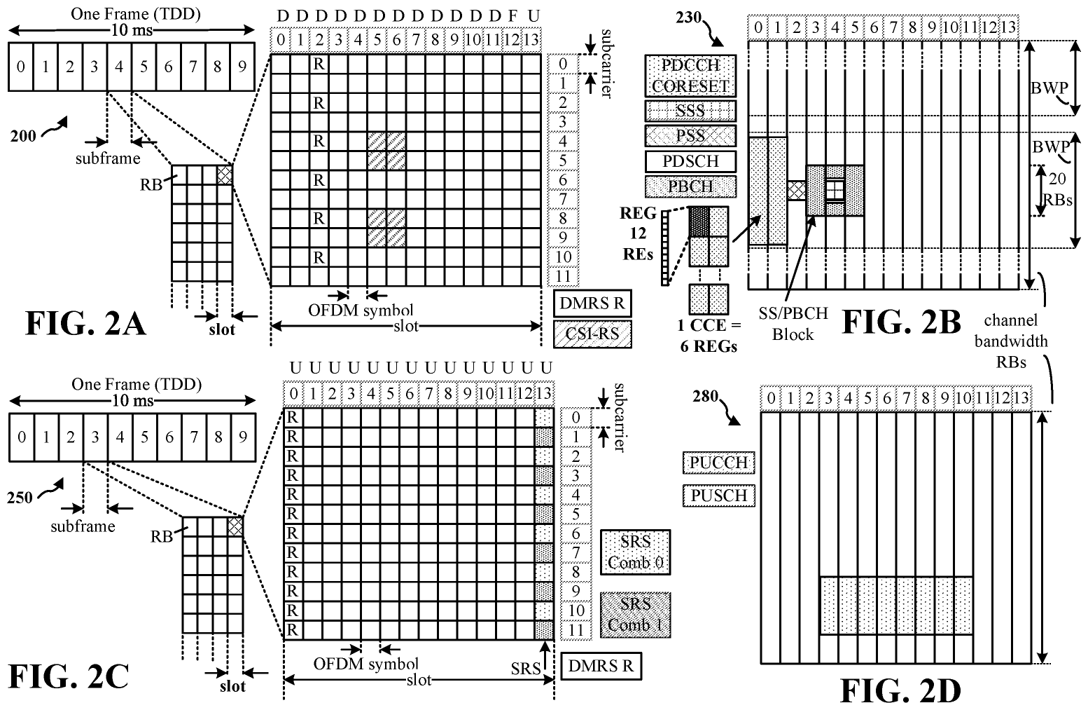

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

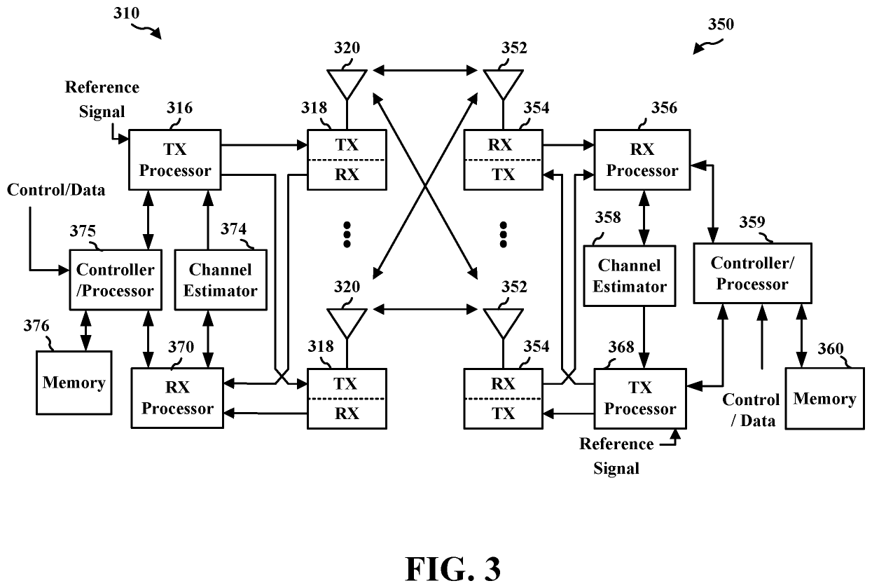

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

In wireless communication, maximum permissible exposure (MPE) is a regulation to limit the amount of maximum transmission power in the direct path of a human body. For instance, if a human body is in the direct path of a transmitted beam, this may trigger the detection of an MPE event. In some aspects, a UE may perform transmission (Tx) capping when detecting an MPE event. Based on the MPE event, depending on the distance between the transmitting device and the user or human body, the amount of Tx capping may be different. For example, if the distance between the human body and the transmitting device, e.g., a UE, is close, the Tx may be capped at one amount, e.g., 8 dBm. Also, if the distance between the human body and the transmitting device is farther, the Tx may be capped at a higher amount, e.g., 34 dBm.

For some detected MPE events, downlink transmissions may be acceptable, as the human body is far away from the transmitting device, e.g., a base station. However, for these same detected MPE events, uplink transmissions may not be acceptable, as the human body is closer to the transmitting device, e.g., a UE. As such, uplink transmissions that correspond to MPE events may utilize an alternative uplink beam to ensure that the uplink transmissions are successfully transmitted.

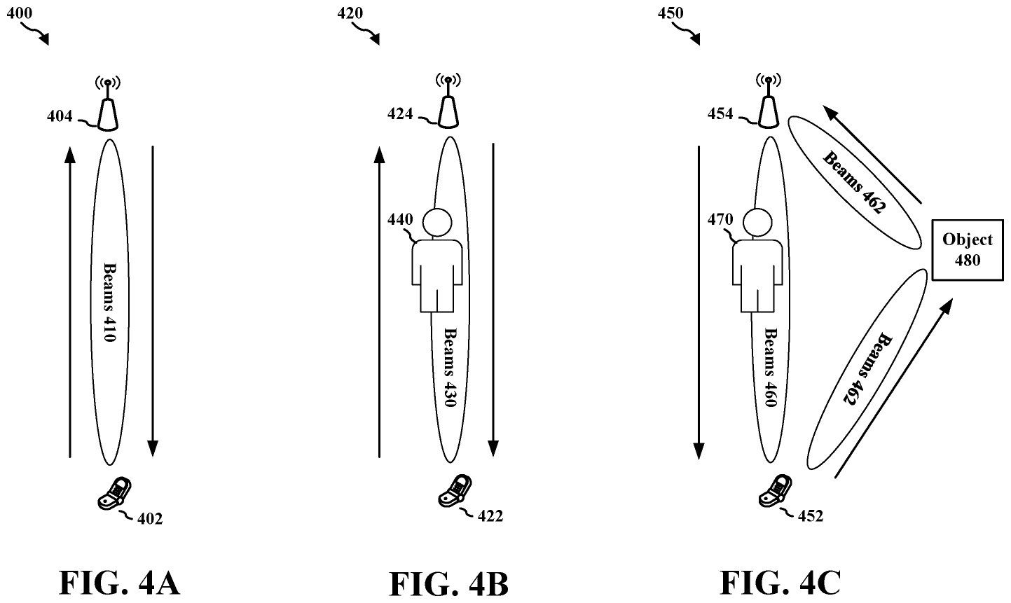

FIGS. 4A, 4B, and 4C are diagrams 400, 420, and 450, respectively, illustrating example communication between a UE and a base station. As shown in FIG. 4A, diagram 400 includes UE 402 transmitting and/or receiving one or more beams, e.g., beams 410, with base station 404. In the scenario in FIG. 4A, both uplink (UL) and downlink (DL) transmissions may be acceptable, as there is no MPE event detected. As shown in FIG. 4B, diagram 420 includes UE 422 transmitting and/or receiving one or more beams, e.g., beams 430, with base station 424. In the scenario in FIG. 4B, based on the MPE event detected due to human body 440, downlink transmissions may be acceptable, but uplink transmissions may not be acceptable. As shown in FIG. 4C, diagram 450 includes UE 452 transmitting and/or receiving one or more beams, e.g., beams 460 and 462, with base station 454. In the scenario in FIG. 4C, based on the MPE event detected due to human body 470, downlink transmissions may be acceptable, but direct uplink transmissions may not be acceptable. Accordingly, the uplink transmissions may be altered to reflect off of object 480 in order to avoid human body 470.

Aspects of wireless communication may include MPE mitigation information that may be transmitted from a UE to a base station. UEs may also investigate MPE mitigation information and specify the corresponding information in a report that is transmitted to a base station. For example, a UE may report a power management maximum power reduction (P-MPR) report. In some aspects, it may be beneficial for the P-MPR report to include a panel level and/or a beam level. Additionally, it may be beneficial for the P-MPR report to include a maximum reported number of panels, e.g., a single panel or multiple panels.

Moreover, when reporting MPE mitigation information, a UE may report a synchronization signal block (SSB) resource indicator (SSBRI), a channel state information reference signal (CSI-RS) resource indicator (CRI) and/or an indication of panel selection. The indication of panel selection may indicate alternative UE panel(s) or transmission (Tx) beam(s) for uplink (UL) transmissions. Also, the indication of panel selection may indicate a feasible UE panel(s) or Tx beam(s) for UL transmissions, which may take the MPE effect into account. It may also be beneficial to include details of the indication of panel selection, e.g., an explicit indication or an implicit indication.

Aspects of wireless communication may also include down-selecting at least one option for a beam measurement or a reporting enhancement in order to facilitate inter-transmission-reception point (inter-TRP) beam pairing. In one aspect, in a CSI report, a UE may report a certain number of beam pairs/groups, e.g., N beam pairs/groups, where N is greater than 1, and a certain number of beams per pair/group, e.g., M beams per pair/group, where M is greater than or equal to 1. There may be different beams in different beam pairs/groups that can be received simultaneously. In some aspects, it may be beneficial if the amount of beams per pair/group (e.g., M) may be equal or different across different beam pairs/groups.

In another aspect, in a CSI report, a UE may report a certain number of beam pairs/groups, e.g., N beam pairs/groups, where N is greater than or equal to 1, and a certain number of beams per pair/group, e.g., M beams per pair/group, where M is greater than 1. Also, there may be different beams within a pair/group that can be received simultaneously.

In another aspect, a UE may report a certain number of beams, e.g., M beams, where M is greater than or equal to 1, in a certain number of CSI reports, e.g., N CSI reports, where N is greater than 1. The amount of CSI reports may correspond to a report setting, e.g., an N report setting. Also, there may be different beams in different CSI reports that can be received simultaneously. In some aspects, it may be beneficial if UEs introduce an association between different CSI reports. Also, it may be beneficial if UEs differentiate reported measurements for beams that are received simultaneously compared to beams that are not received simultaneously. Further, it may be beneficial if UEs introduce an indication along with the CSI reports to indicate whether the beams in different CSI reports can be received simultaneously.

Aspects of the present disclosure may allow UEs to introduce an association between different CSI reports. Aspects of the present disclosure may also allow UEs to differentiate reported measurements for beams that are received simultaneously compared to beams that are not received simultaneously. Moreover, aspects of the present disclosure may also allow UEs to introduce an indication along with the CSI reports to indicate whether the beams in different CSI reports can be received simultaneously. For instance, aspects of the present disclosure may include beam reports, e.g., CSI reports, for MPE events with multiple parts, which may indicate uplink beams, downlink beams, and/or UE panels.

In some instances, aspects of the present disclosure may configure a CSI report with an indication of MPE reporting, e.g., an mpe-Reporting parameter, such as a certain bit configuration, e.g., a P bit configuration. For instance, a UE may be configured to report an MPE value and/or a P bit in a CSI report. When a certain parameter, e.g., an mpe-Reporting parameter, is indicated by a RRC configuration, there may be one P bit in the CSI report to indicate the 1MPE value for the reported panel or beams. For example, if the P bit is set to 0, i.e., P=0, the power backoff for the reported panel or beams due to the MPE event may be less than a threshold, e.g., P_MPR_0. If the P bit is set to 1, i.e., P=1, the power backoff for the reported panel or beams due to the MPE event may be greater than a threshold, e.g., P_MPR_0. Accordingly, the MPE value may be indicated in the CSI report based on a power backoff for a reported panel.

Additionally, a UE may report at least one additional MPE value in a CSI report, such as when a UE includes an indication of MPE reporting, e.g., when a P bit is set to a value of 1, in a CSI report. Also, the CSI report may have multiple parts or portions, e.g., two parts or portions. For example, a first part of a CSI report may include at least one of a SSBRI, a CRI, one or more beam metrics (e.g., a layer 1 (L1) reference signal received power (L1-RSRP), or a L1-signal-to-interference plus noise ratio (L1-SINR)), which may be used for a downlink related CSI report, and a P bit. A second part of a CSI report may include an additional 1MPE value, e.g., two bits per reported MPE value, if a corresponding P bit is set to a value of 1, as indicated in Table 1 below.

TABLE 1

| MPE value vs. Threshold | Reported MPE value |
|---|---|
| MPE value > threshold0 | 00 |
| threshold0 > MPE value > threshold1 | 01 |
| threshold1 > MPE value > threshold2 | 10 |
| threshold2 > MPE value > threshold3 | 11 |

As shown in Table 1, if the MPE value is greater than a threshold, e.g., threshold0, the UE may report a certain MPE value, e.g., an MPE value of 00. If the MPE value is greater than one threshold, e.g., threshold1, and less than another threshold, e.g., threshold0, the UE may report a certain MPE value, e.g., an 1MPE value of 01. Additionally, if the MPE value is greater than one threshold, e.g., threshold2, and less than another threshold, e.g., threshold1, the UE may report a certain MPE value, e.g., an MPE value of 10. If the MPE value is greater than one threshold, e.g., threshold3, and less than another threshold, e.g., threshold2, the UE may report a certain MPE value, e.g., an MPE value of 11.

In some aspects, the MPE value in the CSI report may include different types of values. For instance, the MPE value may be associated with a P-MPR value for the reported panel or beams. In some instances, the MPE value may be associated with a virtual power headroom report (PHR) value for the reported panel or beams. Moreover, the MPE value may be associated with an uplink RSRP for the reported panel or beams.

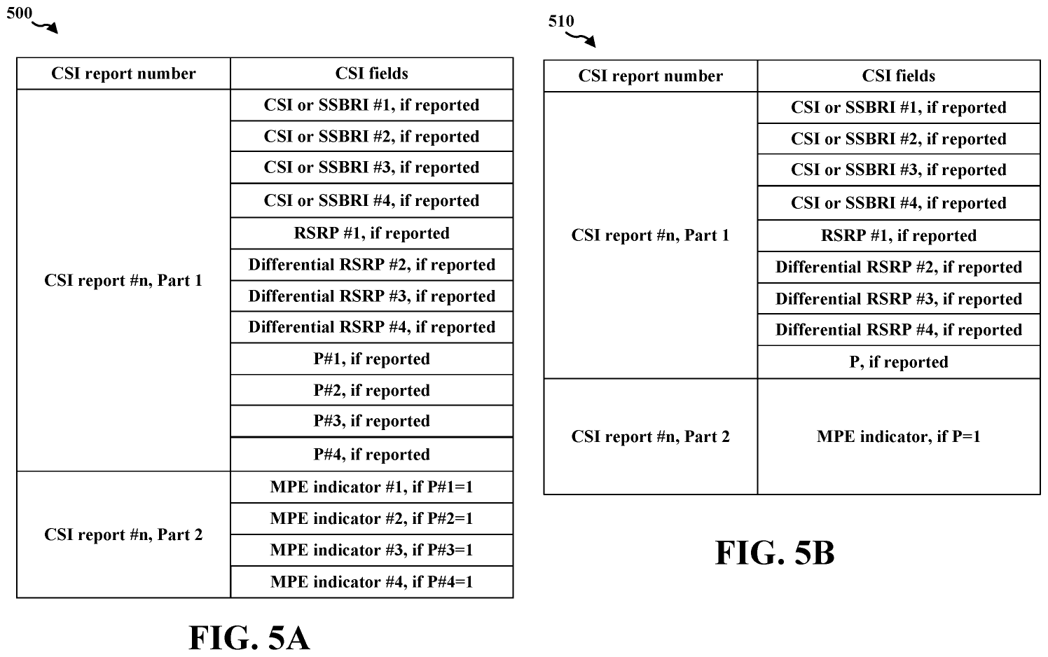

FIGS. 5A and 5B are diagrams 500 and 510, respectively, illustrating example information in a CSI report for wireless communication. FIG. 5A shows one example of a CSI report, where the MPE value is indicated per beam. As shown in FIG. 5A, the CSI report may contain two parts. A first part of the CSI report (part 1) may include a certain amount of beams, e.g., four (4) beams. There may also be a certain bit, e.g., a P bit, for each of the beams, e.g., four (4) bits for each of the four (4) beams. The first part of the CSI report may also include a CSI or SSBRI for each of the beams, as well as a RSRP or differential RSRP for each of the beams. As shown in FIG. 5A, a second part of the CSI report (part 2) may include a number of MPE indicators for the MPE value, e.g., four (4) MPE indicators, for each of the beams, e.g., four (4) beams. As shown in FIG. 5A, if a P bit is set to a value of 1, there may be an MPE indicator for the MPE value for each of the multiple beams. Additionally, if the MPE value is associated with an uplink RSRP, then the P bits may correspond to an uplink RSRP.

FIG. 5B shows another example of a CSI report, where the MPE value is indicated per panel for multiple beams. As shown in FIG. 5B, the MPE value can correspond to a UE panel, and the UE panel can be associated with multiple beams. Accordingly, an MPE value may be associated with multiple beams. As shown in FIG. 5B, the UE may report multiple beams per panel. Also, the UE may report an MPE value per panel, which can correspond to a single bit, e.g., a P bit, per panel. As the beams may each share a single panel, there may be a single bit, e.g., a P bit, that is associated with each of the multiple beams for the panel. The first part of the CSI report may also include a CSI or SSBRI for each of the beams, as well as a RSRP or differential RSRP for each of the beams. Further, there may be a single MPE indicator for an MPE value for the entire panel, e.g., if the P bit is set to a value of 1. As shown in FIGS. 5A and 5B, there may be two separate parts or portions in a CSI report, where a separate MPE value may be associated with each of multiple beams (as in FIG. 5A) or a single MPE value may be associated with all of the multiple beams for a panel (as in FIG. 5B). The second part may be reported when at least one P bit in the first part is set to a value of 1.

Some aspects of the present disclosure may include a beam report for an MPE event at a panel level. In some instances, a UE may include a number of bits for a panel in a CSI report, e.g., P bits per panel. Aspects of the present disclosure may enable a UE to report beam metrics, e.g., L1-RSRP or L1-SINR, in a MPE report or a CSI report. For instance, a UE may report a number of bits, e.g., P bits, to indicate whether the reported RS indices are experiencing an MPE event or not.

In one aspect, a UE may configure a CSI report to include a certain number of beam pairs/groups, e.g., N pairs/groups, where N is greater than 1, and a certain number of beams per pair/group, e.g., M beams per pair/group, where M is greater than or equal to 1. For example, a UE can report a first bit, e.g., a first P bit, to indicate the MPE report is associated with a first set of RS in all beam pairs, e.g., a set of first RS in N beam pairs, and a second P bit to indicate the MPE report is associated with a second set of RS in all beam pairs, e.g., a set of second RS in N beam pairs. For a beam pair/group with a single RS in the beam pair, the corresponding MPE report can be indicated by several options. For instance, the corresponding MPE report can be indicated with a first P bit (e.g., P1), or the corresponding MPE report can be indicated with a third P bit (e.g., P3). In some aspects, there may be a certain P bit (e.g., P1) for a first pair of RS, and another P bit (e.g., P2) for a second pair of RS. There may also be an individual P bit (e.g., P3) for single panel cases.

In another aspect, a UE may configure in a CSI report to report an amount of beam pairs/groups, e.g., N pairs/groups, where N is greater than or equal to 1, and an amount of beams per pair/group, e.g., M beams per pair/group, where M is greater than 1. For example, a UE may report a first P bit (e.g., P1) to indicate the MPE report is associated with a first set of RS in all beam pairs, e.g., a set of first RS in N beam pairs. The UE may also report a second P bit (e.g., P2) to indicate the MPE report is associated with a second set of RS in all beam pairs, e.g., a set of second RS in N beam pairs.

In yet another aspect, a UE may report a certain number of beams, e.g., M beams where M is greater than or equal to 1, in a certain number of CSI reports, e.g., N CSI reports where N is greater than 1, which can correspond to a certain number of report settings, e.g., N report settings. For instance, a UE can report a P bit to indicate the MPE value per CSI report. For example, a UE can report a certain bit, e.g., a n^{th} P bit, to indicate the MPE value for the set of RS in the corresponding CSI report, e.g., a n^{th} CSI report.

Aspects of the present disclosure may also include a beam report for an uplink beam or panel when experiencing an MPE event. For instance, aspects of the present disclosure may configure a CSI report with an indication of MPE reporting, e.g., an mpe-Reporting parameter, where a UE can be configured to report an MPE issue. In some instances, when the indication of MPE reporting is indicated, e.g., an mpe-Reporting parameter, there may be one P bit in the CSI report to indicate there is an MPE issue for the reported panel or beams. For example, if a P bit is set to 0, i.e., P=0, the power backoff for the reported panel or beams due to the MPE event may be less than a threshold, e.g., P_MPR_0. Otherwise, if the P bit is set to 1, i.e., P=1, the power backoff for the reported panel or beams due to the MPE event may be greater than a threshold, e.g., P_MPR_0.

In some aspects, the CSI report may include two parts, where the CSI report is associated with additional UL beams or panels. For instance, when a CSI report includes an indication of MPE reporting, e.g., an mpe-Reporting parameter, a UE can report additional or alternative uplink (UL) beams or panels in the CSI report. For example, if a P bit is set to 1, i.e., P=1, the UE may report additional or alternative UL beams or panels in the CSI report. The first part of the CSI report may include at least one of a SSBRI, a CRI, beam metrics (L1-RSRP or L1-SINR), and a P bit. The second part of the CSI report may include an additional ID for UL beams or panels. Further, additional or alternative UL beams or panels in the CSI report may correspond to a number of different values. For example, the additional or alternative UL beams or panels may correspond to a SSBRI ID, a CRI ID, and/or a SRS ID. Further, the additional or alternative UL beams or panels may correspond to a panel ID. The additional or alternative UL beams or panels may also be a closed loop index in power control. Moreover, the additional or alternative UL beams or panels may be a SRS resource set ID.

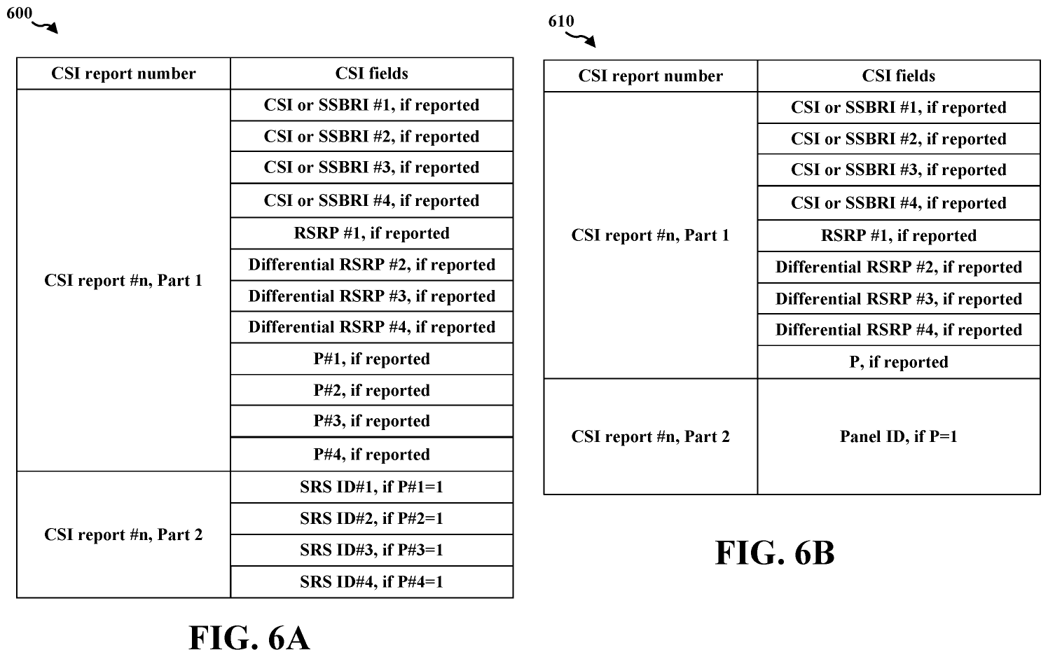

FIGS. 6A and 6B are diagrams 600 and 610, respectively, illustrating example information in a CSI report for wireless communication. FIG. 6A shows one example of a CSI report which includes an alternative UL beam. As shown in FIG. 6A, the CSI report may contain two parts. A first part of the CSI report (e.g., part 1) may include a certain amount of beams, e.g., four (4) beams. There may also be a certain bit, e.g., a P bit, for each of the beams, e.g., four (4) bits for each of the four (4) beams. As shown in FIG. 6A, if the P bit is set to 1, then additional or alternative beams may be reported. For instance, if a P bit is set to 1, this may correspond to an unacceptable beam based on the MPE value, so the UE can report alternative UL beams. The first part of the CSI report may also include a CSI or SSBRI for each of the beams, as well as a RSRP or differential RSRP for each of the beams. As shown in FIG. 6A, a second part of the CSI report (e.g., part 2) may include a number of SRS IDs for the MPE value, e.g., four (4) SRS IDs, for each of the beams, e.g., four (4) beams. As shown in FIG. 6A, if a P bit for a particular beam is set to a value of 1, there may be an SRS ID for that particular beam.

FIG. 6B shows another example of a CSI report which includes an alternative UL panel. As shown in FIG. 6B, the MPE value can correspond to a UE panel, and the UE panel can be associated with multiple beams. Accordingly, an MPE value may be associated with multiple beams. As shown in FIG. 6B, the UE may report multiple beams per panel. Also, the UE may report an MPE value per panel, which can correspond to a single bit, e.g., a P bit, per panel. As the beams may each share a single panel, there may be a single bit, e.g., a P bit, that is associated with each of the multiple beams for the panel. As shown in FIG. 6B, if the P bit is set to 1, then additional or alternative panels may be reported. For example, if a P bit is set to 1, this may correspond to an unacceptable panel based on the MPE value, so the UE may report alternative UL panels. Further, as shown in FIG. 6B, the alternative UL panel may correspond to a single panel ID. The first part of the CSI report may also include a CSI or SSBRI for each of the beams, as well as a RSRP or differential RSRP for each of the beams. Further, in the second part of the CSI report, there may be a single panel ID for the entire panel, e.g., if the P bit is set to a value of 1. As shown in FIGS. 6A and 6B, there can be two separate parts or portions in a CSI report, where a separate SRS ID may be associated with each of multiple beams (as in FIG. 6A) or a single panel ID may be associated with all of the multiple beams for a panel (as in FIG. 6B).

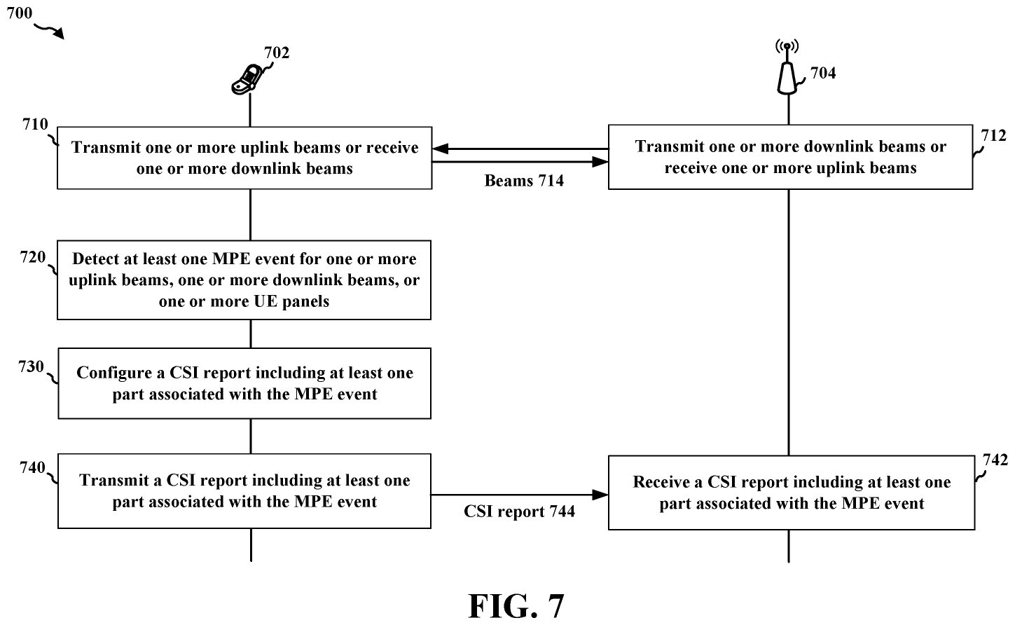

FIG. 7 is a diagram 700 illustrating communication between a UE 702 and a base station 704. The UE 702 may correspond to UE 104, 350, 402/422/452, and apparatus 1002, and the base station 704 may correspond to base station 180, 310, 404/424/454, and apparatus 1102.

At 710, UE 702 may transmit, to base station 704, one or more uplink beams, e.g., beams 714, or receive, from the base station, one or more downlink beams, e.g., beams 714, where at least one maximum permissible exposure (MPE) event is detected for the one or more uplink beams or the one or more downlink beams. At 712, base station 704 may transmit, to UE 702, one or more downlink beams, e.g., beams 714, or receive, from the UE, one or more uplink beams, e.g., beams 714.

At 720, UE 702 may detect at least one maximum permissible exposure (MPE) event for at least one of one or more uplink beams, one or more downlink beams, e.g., beams 714, or one or more UE panels.

At 730, UE 702 may configure, upon detecting the at least one MPE event, a channel state information (CSI) report, e.g., CSI report 744, including at least one part associated with the MPE event, the at least one part indicating at least one of the one or more uplink beams, the one or more downlink beams, or the one or more UE panels.

In some aspects, the at least one part of the CSI report, e.g., CSI report 744, may include a MPE value corresponding to the MPE event, the MPE value being associated with at least one of the one or more uplink beams, the one or more downlink beams, or the one or more UE panels. The MPE value may correspond to at least one bit in the CSI report, e.g., CSI report 744. The at least one part may indicate at least one of a synchronization signal block (SSB) resource indicator (SSBRI), a channel state information reference signal (CSI-RS) resource indicator (CRI), a layer 1 (L1) reference signal received power (L1-RSRP), or a L1-signal-to-interference plus noise ratio (L1-SINR).

In some instances, the at least one part of the CSI report, e.g., CSI report 744, may include a first part and a second part, the second part indicating at least one of an additional MPE value, a beam identifier (ID), or a panel ID. The at least one part may include a first part and a second part if at least one bit in the CSI report is set to a value of one (1). The additional MPE value may be associated with at least one of the one or more uplink beams, the one or more downlink beams, e.g., beams 714, or the one or more UE panels, where the additional MPE value may correspond to at least one bit in the CSI report. The additional MPE value may include at least one of a power management maximum power reduction (P-MPR) value, a virtual power headroom report (PHR) value, or an uplink reference signal received power (RSRP) corresponding to at least one of the one or more uplink beams, the one or more downlink beams, e.g., beams 714, or the one or more UE panels. Also, the CSI report, e.g., CSI report 744, may indicate one or more alternative uplink (UL) beams or one or more alternative panels. Moreover, the one or more alternative UL beams or the one or more alternative panels may correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

Additionally, the CSI report, e.g., CSI report 744, may include one or more bits for each of the one or more UE panels, where the one or more bits may be associated with one or more sets of reference signals (RS). If the CSI report, e.g., CSI report 744, is associated with at least two beam groups and one or more beams per beam group, a first bit of the one or more bits may correspond to a first set of the one or more sets of RS and a second bit of the one or more bits may correspond to a second set of the one or more sets of RS. If the CSI report, e.g., CSI report 744, is associated with one or more beam groups and at least two beams per beam group, a first bit of the one or more bits may correspond to a first set of the one or more sets of RS and a second bit of the one or more bits may correspond to a second set of the one or more sets of RS. If the CSI report, e.g., CSI report 744, is associated with multiple CSI reports, a last bit of the one or more bits may correspond to the one or more sets of RS in a last CSI report of the multiple CSI reports. Further, the CSI report, e.g., CSI report 744, may include at least one bit indicating that the at least one MPE event corresponds to at least one of the one or more uplink beams, the one or more downlink beams, or the one or more UE panels.

At 740, UE 702 may transmit, to base station 704, the CSI report, e.g., CSI report 744, including the at least one part associated with the MPE event. At 742, base station 704 may receive, from UE 702, a CSI report, e.g., CSI report 744, including at least one part associated with a maximum permissible exposure (MPE) event, the at least one part indicating at least one of the one or more uplink beams, the one or more downlink beams, or one or more UE panels.

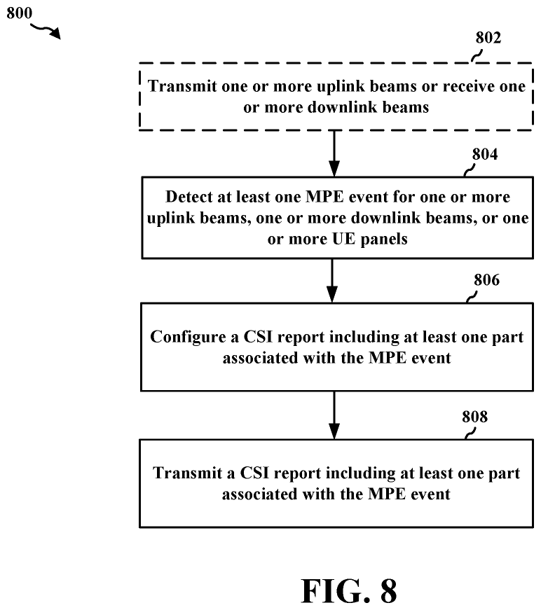

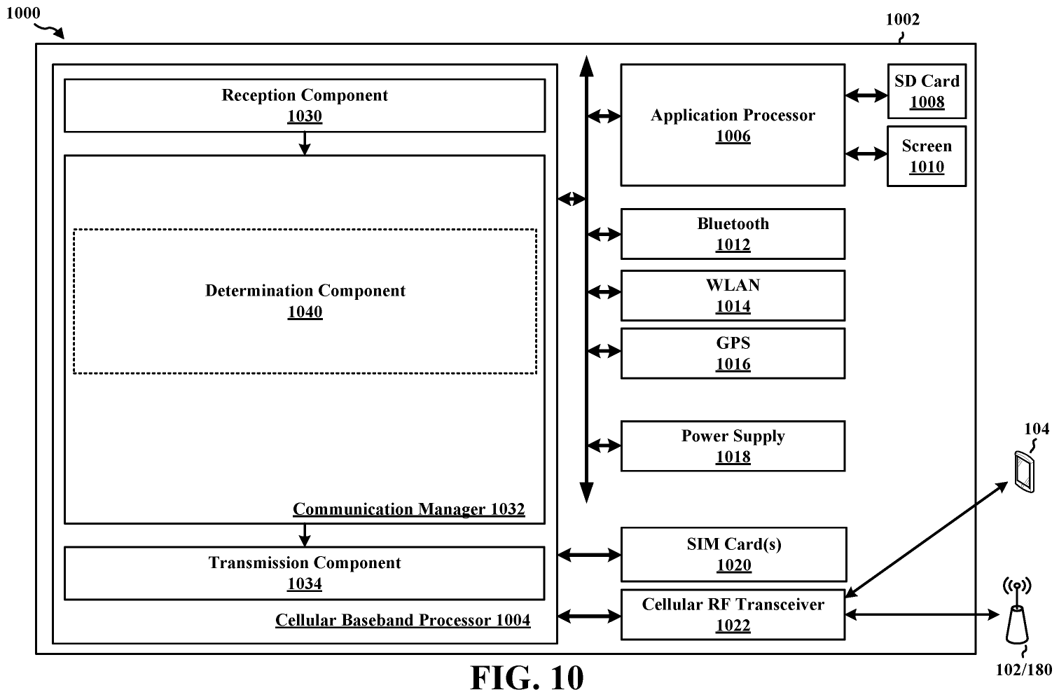

FIG. 8 is a flowchart 800 of a method of wireless communication. The method may be performed by an apparatus, such as a UE or a component of a UE (e.g., the UE 104, 350, 402/422/452; apparatus 1002). Optional aspects are illustrated with a dashed line. The methods described herein can provide a number of benefits, such as improving communication signaling, resource utilization, and/or power savings. At 802, the apparatus may transmit, to a base station, one or more uplink beams or receive, from the base station, one or more downlink beams, where at least one maximum permissible exposure (MPE) event is detected for the one or more uplink beams or the one or more downlink beams, as described in connection with the examples in FIGS. 4A-7. For example, as described in 710 of FIG. 7, UE 702 may transmit, to a base station, one or more uplink beams or receive, from the base station, one or more downlink beams, where at least one MPE event is detected for the one or more uplink beams or the one or more downlink beams. Further, 802 may be performed by determination component 1040 in FIG. 10.

At 804, the apparatus may detect at least one maximum permissible exposure (MPE) event for at least one of one or more uplink beams, one or more downlink beams, or one or more UE panels, as described in connection with the examples in FIGS. 4A-7. For example, as described in 720 of FIG. 7, UE 702 may detect at least one maximum permissible exposure (MPE) event for at least one of one or more uplink beams, one or more downlink beams, or one or more UE panels. Further, 804 may be performed by determination component 1040 in FIG. 10.

At 806, the apparatus may configure, upon detecting the at least one MPE event, a channel state information (CSI) report including at least one part associated with the MPE event, the at least one part indicating at least one of the one or more uplink beams, the one or more downlink beams, or the one or more UE panels, as described in connection with the examples in FIGS. 4A-7. For example, as described in 730 of FIG. 7, UE 702 may configure, upon detecting the at least one MPE event, a channel state information (CSI) report including at least one part associated with the MPE event, the at least one part indicating at least one of the one or more uplink beams, the one or more downlink beams, or the one or more UE panels. Further, 806 may be performed by determination component 1040 in FIG. 10.

In some aspects, the at least one part of the CSI report may include a MPE value corresponding to the MPE event, the MPE value being associated with at least one of the one or more uplink beams, the one or more downlink beams, or the one or more UE panels. The MPE value may correspond to at least one bit in the CSI report. The at least one part may indicate at least one of a synchronization signal block (SSB) resource indicator (SSBRI), a channel state information reference signal (CSI-RS) resource indicator (CRI), a layer 1 (L1) reference signal received power (L1-RSRP), or a L1-signal-to-interference plus noise ratio (L1-SINR).

In some instances, the at least one part of the CSI report may include a first part and a second part, the second part indicating at least one of an additional MPE value, a beam identifier (ID), or a panel ID. The at least one part may include a first part and a second part if at least one bit in the CSI report is set to a value of one (1). The additional MPE value may be associated with at least one of the one or more uplink beams, the one or more downlink beams, or the one or more UE panels, where the additional MPE value may correspond to at least one bit in the CSI report. The additional MPE value may include at least one of a power management maximum power reduction (P-MPR) value, a virtual power headroom report (PHR) value, or an uplink reference signal received power (RSRP) corresponding to at least one of the one or more uplink beams, the one or more downlink beams, or the one or more UE panels. Also, the CSI report may indicate one or more alternative uplink (UL) beams or one or more alternative panels. Moreover, the one or more alternative UL beams or the one or more alternative panels may correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

Additionally, the CSI report may include one or more bits for each of the one or more UE panels, where the one or more bits may be associated with one or more sets of reference signals (RS). If the CSI report is associated with at least two beam groups and one or more beams per beam group, a first bit of the one or more bits may correspond to a first set of the one or more sets of RS and a second bit of the one or more bits may correspond to a second set of the one or more sets of RS. If the CSI report is associated with one or more beam groups and at least two beams per beam group, a first bit of the one or more bits may correspond to a first set of the one or more sets of RS and a second bit of the one or more bits may correspond to a second set of the one or more sets of RS. If the CSI report is associated with multiple CSI reports, a last bit of the one or more bits may correspond to the one or more sets of RS in a last CSI report of the multiple CSI reports. Further, the CSI report may include at least one bit indicating that the at least one MPE event corresponds to at least one of the one or more uplink beams, the one or more downlink beams, or the one or more UE panels.

At 808, the apparatus may transmit, to a base station, the CSI report including the at least one part associated with the MPE event, as described in connection with the examples in FIGS. 4A-7. For example, as described in 740 of FIG. 7, UE 702 may transmit, to a base station, the CSI report including the at least one part associated with the MPE event. Further, 808 may be performed by determination component 1040 in FIG. 10.

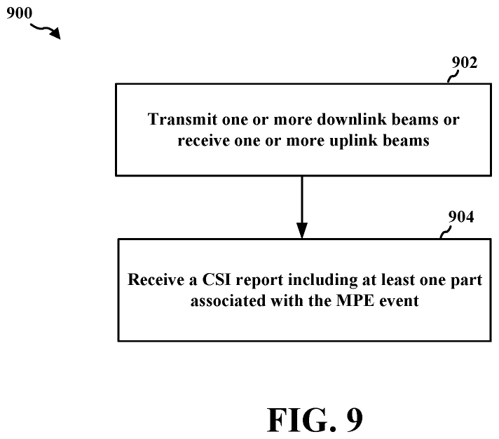

FIG. 9 is a flowchart 900 of a method of wireless communication. The method may be performed by an apparatus, such as base station or a component of a base station (e.g., the base station 180, 310, 404/424/454; apparatus 1102). Optional aspects are illustrated with a dashed line. The methods described herein can provide a number of benefits, such as improving communication signaling, resource utilization, and/or power savings.

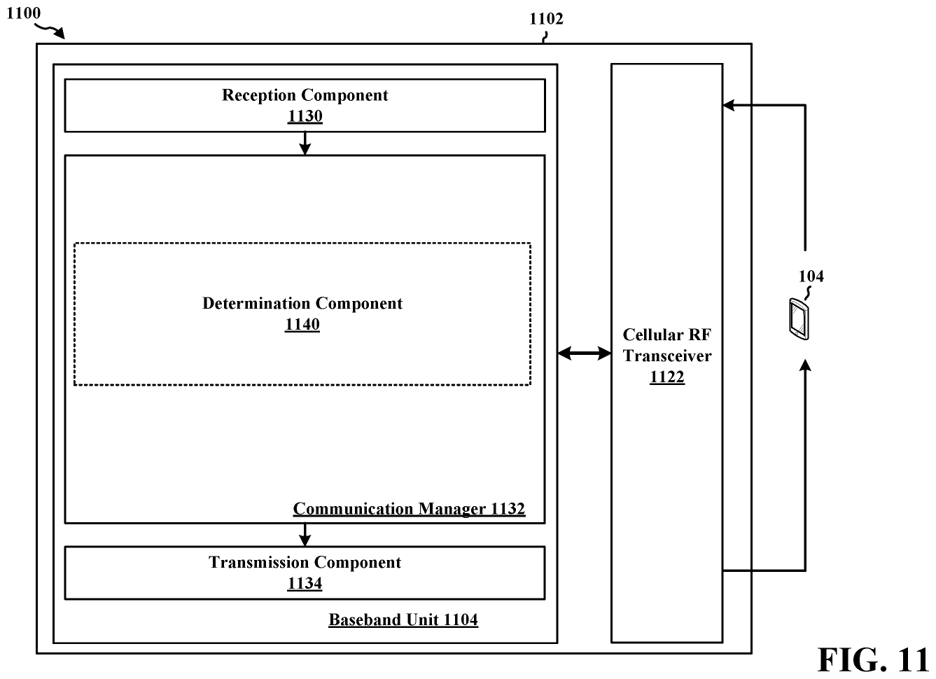

At 902, the apparatus may transmit, to a UE, one or more downlink beams or receive, from the UE, one or more uplink beams, as described in connection with the examples in FIGS. 4A-7. For example, as described in 712 of FIG. 7, base station 704 may transmit, to a UE, one or more downlink beams or receive, from the UE, one or more uplink beams. Further, 902 may be performed by determination component 1140 in FIG. 11.

At 904, the apparatus may receive, from the UE, a channel state information (CSI) report including at least one part associated with a maximum permissible exposure (MPE) event, the at least one part indicating at least one of the one or more uplink beams, the one or more downlink beams, or one or more UE panels, as described in connection with the examples in FIGS. 4A-7. For example, as described in 742 of FIG. 7, base station 704 may receive, from the UE, a channel state information (CSI) report including at least one part associated with a maximum permissible exposure (MPE) event, the at least one part indicating at least one of the one or more uplink beams, the one or more downlink beams, or one or more UE panels. Further, 904 may be performed by determination component 1140 in FIG. 11.

In some aspects, the at least one part of the CSI report may include a MPE value corresponding to the MPE event, the MPE value being associated with at least one of the one or more uplink beams, the one or more downlink beams, or the one or more UE panels. The MPE value may correspond to at least one bit in the CSI report. The at least one part may indicate at least one of a synchronization signal block (SSB) resource indicator (SSBRI), a channel state information reference signal (CSI-RS) resource indicator (CRI), a layer 1 (L1) reference signal received power (L1-RSRP), or a L1-signal-to-interference plus noise ratio (L1-SINR).

In some instances, the at least one part of the CSI report may include a first part and a second part, the second part indicating at least one of an additional MPE value, a beam identifier (ID), or a panel ID. The at least one part may include a first part and a second part if at least one bit in the CSI report is set to a value of one (1). The additional MPE value may be associated with at least one of the one or more uplink beams, the one or more downlink beams, or the one or more UE panels, where the additional MPE value may correspond to at least one bit in the CSI report. The additional MPE value may include at least one of a power management maximum power reduction (P-MPR) value, a virtual power headroom report (PHR) value, or an uplink reference signal received power (RSRP) corresponding to at least one of the one or more uplink beams, the one or more downlink beams, or the one or more UE panels. Also, the CSI report may indicate one or more alternative uplink (UL) beams or one or more alternative panels. Moreover, the one or more alternative UL beams or the one or more alternative panels may correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

Additionally, the CSI report may include one or more bits for each of the one or more UE panels, where the one or more bits may be associated with one or more sets of reference signals (RS). If the CSI report is associated with at least two beam groups and one or more beams per beam group, a first bit of the one or more bits may correspond to a first set of the one or more sets of RS and a second bit of the one or more bits may correspond to a second set of the one or more sets of RS. If the CSI report is associated with one or more beam groups and at least two beams per beam group, a first bit of the one or more bits may correspond to a first set of the one or more sets of RS and a second bit of the one or more bits may correspond to a second set of the one or more sets of RS. If the CSI report is associated with multiple CSI reports, a last bit of the one or more bits may correspond to the one or more sets of RS in a last CSI report of the multiple CSI reports. Further, the CSI report may include at least one bit indicating that the at least one MPE event corresponds to at least one of the one or more uplink beams, the one or more downlink beams, or the one or more UE panels.

FIG. 10 is a diagram 1000 illustrating an example of a hardware implementation for an apparatus 1002. The apparatus 1002 is a UE and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 350 of FIG. 3) and include the aforediscussed additional modules of the apparatus 1002.

The communication manager 1032 includes a determination component 1040 that may be configured to transmit, to a base station, one or more uplink beams or receive, from the base station, one or more downlink beams, where at least one MPE event is detected for the one or more uplink beams or the one or more downlink beams, e.g., as described in connection with 802 in FIG. 8. Determination component 1040 may also be configured to detect at least one maximum permissible exposure (MPE) event for at least one of one or more uplink beams, one or more downlink beams, or one or more UE panels, e.g., as described in connection with 804 in FIG. 8. Determination component 1040 may also be configured to configure, upon detecting the at least one MPE event, a channel state information (CSI) report including at least one part associated with the MPE event, the at least one part indicating at least one of the one or more uplink beams, the one or more downlink beams, or the one or more UE panels, e.g., as described in connection with 806 in FIG. 8. Determination component 1040 may also be configured to transmit, to a base station, the CSI report including the at least one part associated with the MPE event, e.g., as described in connection with 808 in FIG. 8.

The apparatus may include additional components that perform each of the blocks of the algorithm in the aforementioned flowcharts of FIGS. 7 and 8. As such, each block in the aforementioned flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof

In one configuration, the apparatus 1002, and in particular the cellular baseband processor 1004, includes means for transmitting, to a base station, one or more uplink beams or means for receiving, from the base station, one or more downlink beams, where at least one MPE event is detected for the one or more uplink beams or the one or more downlink beams; means for detecting at least one maximum permissible exposure (MPE) event for at least one of one or more uplink beams, one or more downlink beams, or one or more UE panels; means for configuring, upon detecting the at least one MPE event, a channel state information (CSI) report including at least one part associated with the MPE event, the at least one part indicating at least one of the one or more uplink beams, the one or more downlink beams, or the one or more UE panels; and means for transmitting, to a base station, the CSI report including the at least one part associated with the MPE event. The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 11 is a diagram 1100 illustrating an example of a hardware implementation for an apparatus 1102. The apparatus 1102 is a base station (BS) and includes a baseband unit 1104. The baseband unit 1104 may communicate through a cellular RF transceiver 1122 with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the BS 310 and may include the memory 376 and/or at least one of the TX processor 316, the RX processor 370, and the controller/processor 375.

The communication manager 1132 includes a determination component 1140 that may be configured to transmit, to a user equipment (UE), one or more downlink beams or receive, from the UE, one or more uplink beams, e.g., as described in connection with 902 in FIG. 9. Determination component 1140 may also be configured to receive, from the UE, a channel state information (CSI) report including at least one part associated with a maximum permissible exposure (MPE) event, the at least one part indicating at least one of the one or more uplink beams, the one or more downlink beams, or one or more UE panels, e.g., as described in connection with 904 in FIG. 9.

The apparatus may include additional components that perform each of the blocks of the algorithm in the aforementioned flowcharts of FIGS. 7 and 9. As such, each block in the aforementioned flowcharts of FIGS. 7 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof,

In one configuration, the apparatus 1102, and in particular the baseband unit 1104, includes means for transmitting, to a user equipment (UE), one or more downlink beams or means for receiving, from the UE, one or more uplink beams; and means for receiving, from the UE, a channel state information (CSI) report including at least one part associated with a maximum permissible exposure (MPE) event, the at least one part indicating at least one of the one or more uplink beams, the one or more downlink beams, or one or more UE panels. The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication of a user equipment (UE). The method includes detecting at least one maximum permissible exposure (MPE) event for at least one of one or more uplink beams, one or more downlink beams, or one or more UE panels; configuring, upon detecting the at least one MPE event, a channel state information (CSI) report including at least one part associated with the MPE event, the at least one part indicating at least one of the one or more uplink beams, the one or more downlink beams, or the one or more UE panels; and transmitting, to a base station, the CSI report including the at least one part associated with the MPE event.

Aspect 2 is the method of aspect 1, where the at least one part of the CSI report includes a MPE value corresponding to the MPE event, the MPE value being associated with at least one of the one or more uplink beams, the one or more downlink beams, or the one or more UE panels.

Aspect 3 is the method of any of aspects 1 and 2, where the MPE value corresponds to at least one bit in the CSI report.

Aspect 4 is the method of any of aspects 1 to 3, where the at least one part indicates at least one of a synchronization signal block (SSB) resource indicator (SSBRI), a channel state information reference signal (CSI-RS) resource indicator (CRI), a layer 1 (L1) reference signal received power (L1-RSRP), or a L1-signal-to-interference plus noise ratio (L1-SINR).

Aspect 5 is the method of any of aspects 1 to 4, where the at least one part of the CSI report includes a first part and a second part, the second part indicating at least one of an additional MPE value, a beam identifier (ID), or a panel ID.

Aspect 6 is the method of any of aspects 1 to 5, where the at least one part includes a first part and a second part if at least one bit in the CSI report is set to a value of one (1).

Aspect 7 is the method of any of aspects 1 to 6, where the additional MPE value is associated with at least one of the one or more uplink beams, the one or more downlink beams, or the one or more UE panels, where the additional MPE value corresponds to at least one bit in the CSI report.

Aspect 8 is the method of any of aspects 1 to 7, where the additional MPE value includes at least one of a power management maximum power reduction (P-MPR) value, a virtual power headroom report (PHR) value, or an uplink reference signal received power (RSRP) corresponding to at least one of the one or more uplink beams, the one or more downlink beams, or the one or more UE panels.

Aspect 9 is the method of any of aspects 1 to 8, where the CSI report indicates one or more alternative uplink (UL) beams or one or more alternative panels.

Aspect 10 is the method of any of aspects 1 to 9, where the one or more alternative UL beams or the one or more alternative panels correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

Aspect 11 is the method of any of aspects 1 to 10, where the CSI report includes one or more bits for each of the one or more UE panels, the one or more bits associated with one or more sets of reference signals (RS).

Aspect 12 is the method of any of aspects 1 to 11, where if the CSI report is associated with at least two beam groups and one or more beams per beam group, a first bit of the one or more bits corresponds to a first set of the one or more sets of RS and a second bit of the one or more bits corresponds to a second set of the one or more sets of RS.

Aspect 13 is the method of any of aspects 1 to 12, where if the CSI report is associated with one or more beam groups and at least two beams per beam group, a first bit of the one or more bits corresponds to a first set of the one or more sets of RS and a second bit of the one or more bits corresponds to a second set of the one or more sets of RS.

Aspect 14 is the method of any of aspects 1 to 13, where if the CSI report is associated with multiple CSI reports, a last bit of the one or more bits corresponds to the one or more sets of RS in a last CSI report of the multiple CSI reports.

Aspect 15 is the method of any of aspects 1 to 14, where the CSI report includes at least one bit indicating that the at least one MPE event corresponds to at least one of the one or more uplink beams, the one or more downlink beams, or the one or more UE panels.

Aspect 16 is the method of any of aspects 1 to 15, further including transmitting, to the base station, the one or more uplink beams or receiving, from the base station, the one or more downlink beams, where the at least one MPE event is detected for the one or more uplink beams or the one or more downlink beams.

Aspect 17 is an apparatus for wireless communication including at least one processor coupled to a memory and configured to implement a method as in any of aspects 1 to 16.

Aspect 18 is an apparatus for wireless communication including means for implementing a method as in any of aspects 1 to 16.

Aspect 19 is a computer-readable medium storing computer executable code, where the code when executed by a processor causes the processor to implement a method as in any of aspects 1 to 16.

Aspect 20 is a method of wireless communication of a base station. The method includes transmitting, to a user equipment (UE), one or more downlink beams or receiving, from the UE, one or more uplink beams; and receiving, from the UE, a channel state information (CSI) report including at least one part associated with a maximum permissible exposure (MPE) event, the at least one part indicating at least one of the one or more uplink beams, the one or more downlink beams, or one or more UE panels.

Aspect 21 is the method of aspect 20, where the at least one part of the CSI report includes a MPE value corresponding to the MPE event, the MPE value being associated with at least one of the one or more uplink beams, the one or more downlink beams, or the one or more UE panels.

Aspect 22 is the method of any of aspects 20 and 21, where the MPE value corresponds to at least one bit in the CSI report.

Aspect 23 is the method of any of aspects 20 to 22, where the at least one part indicates at least one of a synchronization signal block (SSB) resource indicator (SSBRI), a channel state information reference signal (CSI-RS) resource indicator (CR1), a layer 1 (L1) reference signal received power (L1-RSRP), or a L1-signal-to-interference plus noise ratio (L1-SINR).

Aspect 24 is the method of any of aspects 20 to 23, where the at least one part of the CSI report includes a first part and a second part, the second part indicating at least one of an additional MPE value, a beam identifier (ID), or a panel ID.

Aspect 25 is the method of any of aspects 20 to 24, where the at least one part includes a first part and a second part if at least one bit in the CSI report is set to a value of one (1).

Aspect 26 is the method of any of aspects 20 to 25, where the additional MPE value is associated with at least one of the one or more uplink beams, the one or more downlink beams, or the one or more UE panels, where the additional MPE value corresponds to at least one bit in the CSI report.

Aspect 27 is the method of any of aspects 20 to 26, where the additional MPE value includes at least one of a power management maximum power reduction (P-MPR) value, a virtual power headroom report (PHR) value, or an uplink reference signal received power (RSRP) corresponding to at least one of the one or more uplink beams, the one or more downlink beams, or the one or more UE panels.

Aspect 28 is the method of any of aspects 20 to 27, where the CSI report indicates one or more alternative uplink (UL) beams or one or more alternative panels.

Aspect 29 is the method of any of aspects 20 to 28, where the one or more alternative UL beams or the one or more alternative panels correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

Aspect 30 is the method of any of aspects 20 to 29, where the CSI report includes one or more bits for each of the one or more UE panels, the one or more bits associated with one or more sets of reference signals (RS).

Aspect 31 is the method of any of aspects 20 to 30, where if the CSI report is associated with at least two beam groups and one or more beams per beam group, a first bit of the one or more bits corresponds to a first set of the one or more sets of RS and a second bit of the one or more bits corresponds to a second set of the one or more sets of RS.

Aspect 32 is the method of any of aspects 20 to 31, where if the CSI report is associated with one or more beam groups and at least two beams per beam group, a first bit of the one or more bits corresponds to a first set of the one or more sets of RS and a second bit of the one or more bits corresponds to a second set of the one or more sets of RS.

Aspect 33 is the method of any of aspects 20 to 32, where if the CSI report is associated with multiple CSI reports, a last bit of the one or more bits corresponds to the one or more sets of RS in a last CSI report of the multiple CSI reports.

Aspect 34 is the method of any of aspects 20 to 33, where the CSI report includes at least one bit indicating that the at least one MPE event corresponds to at least one of the one or more uplink beams, the one or more downlink beams, or the one or more UE panels.

Aspect 35 is an apparatus for wireless communication including at least one processor coupled to a memory and configured to implement a method as in any of aspects 20 to 34.

Aspect 36 is an apparatus for wireless communication including means for implementing a method as in any of aspects 20 to 34.

Aspect 37 is a computer-readable medium storing computer executable code, where the code when executed by a processor causes the processor to implement a method as in any of aspects 20 to 34.

What is claimed is:

1. A method of wireless communication of a user equipment (UE), comprising:
detecting at least one maximum permissible exposure (MPE) event for at least one of one or more uplink beams, one or more downlink beams, or one or more UE panels;
configuring, upon detecting the at least one MPE event, a channel state information (CSI) report including at least one part associated with the MPE event, the at least one part indicating at least one of the one or more uplink beams, the one or more downlink beams, or the one or more UE panels; and
transmitting, to a base station, the CSI report including the at least one part associated with the MPE event.

2. The method of claim 1, wherein the at least one part of the CSI report includes a MPE value corresponding to the MPE event, the MPE value being associated with at least one of the one or more uplink beams, the one or more downlink beams, or the one or more UE panels.

3. The method of claim 2, wherein the MPE value corresponds to at least one bit in the CSI report.

4. The method of claim 1, wherein the at least one part indicates at least one of a synchronization signal block (SSB) resource indicator (SSBRI), a channel state information reference signal (CSI-RS) resource indicator (CRI), a layer 1 (L1) reference signal received power (L1-RSRP), or a L1-signal-to-interference plus noise ratio (L1-SINR).

5. The method of claim 1, wherein the at least one part of the CSI report includes a first part and a second part, the second part indicating at least one of an additional MPE value, a beam identifier (ID), or a panel ID.

6. The method of claim 5, wherein the at least one part includes a first part and a second part if at least one bit in the CSI report is set to a value of one (1).

7. The method of claim 5, wherein the additional MPE value is associated with at least one of the one or more uplink beams, the one or more downlink beams, or the one or more UE panels, wherein the additional MPE value corresponds to at least one bit in the CSI report.

8. The method of claim 7, wherein the additional MPE value includes at least one of a power management maximum power reduction (P-MPR) value, a virtual power headroom report (PHR) value, or an uplink reference signal received power (RSRP) corresponding to at least one of the one or more uplink beams, the one or more downlink beams, or the one or more UE panels.

9. The method of claim 5, wherein the CSI report indicates one or more alternative uplink (UL) beams or one or more alternative panels.

10. The method of claim 9, wherein the one or more alternative UL beams or the one or more alternative panels correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

11. The method of claim 1, wherein the CSI report includes one or more bits for each of the one or more UE panels, the one or more bits associated with one or more sets of reference signals (RS).

12. The method of claim 11, wherein if the CSI report is associated with at least two beam groups and one or more beams per beam group, a first bit of the one or more bits corresponds to a first set of the one or more sets of RS and a second bit of the one or more bits corresponds to a second set of the one or more sets of RS.

13. The method of claim 11, wherein if the CSI report is associated with one or more beam groups and at least two beams per beam group, a first bit of the one or more bits corresponds to a first set of the one or more sets of RS and a second bit of the one or more bits corresponds to a second set of the one or more sets of RS.

14. The method of claim 11, wherein if the CSI report is associated with multiple CSI reports, a last bit of the one or more bits corresponds to the one or more sets of RS in a last CSI report of the multiple CSI reports.

15. The method of claim 1, wherein the CSI report includes at least one bit indicating that the at least one MPE event corresponds to at least one of the one or more uplink beams, the one or more downlink beams, or the one or more UE panels.

16. The method of claim 1, further comprising:
transmitting, to the base station, the one or more uplink beams or receiving, from the base station, the one or more downlink beams, wherein the at least one MPE event is detected for the one or more uplink beams or the one or more downlink beams.

17. An apparatus for wireless communication of a user equipment (UE), comprising:
a memory; and
at least one processor coupled to the memory and configured to:
detect at least one maximum permissible exposure (MPE) event for at least one of one or more uplink beams, one or more downlink beams, or one or more UE panels;
configure, upon detecting the at least one MPE event, a channel state information (CSI) report including at least one part associated with the MPE event, the at least one part indicating at least one of the one or more uplink beams, the one or more downlink beams, or the one or more UE panels; and
transmit, to a base station, the CSI report including the at least one part associated with the MPE event.

18. A method of wireless communication of a base station, comprising:
transmitting, to a user equipment (UE), one or more downlink beams or receiving, from the UE, one or more uplink beams; and
receiving, from the UE, a channel state information (CSI) report including at least one part associated with a maximum permissible exposure (MPE) event, the at least one part indicating at least one of the one or more uplink beams, the one or more downlink beams, or one or more UE panels.

19. The method of claim 18, wherein the at least one part of the CSI report includes a MPE value corresponding to the MPE event, the MPE value being associated with at least one of the one or more uplink beams, the one or more downlink beams, or the one or more UE panels.

20. The method of claim 19, wherein the MPE value corresponds to at least one bit in the CSI report.

21. The method of claim 18, wherein the at least one part indicates at least one of a synchronization signal block (SSB) resource indicator (SSBRI), a channel state information reference signal (CSI-RS) resource indicator (CRI), a layer 1 (L1) reference signal received power (L1-RSRP), or a L1-signal-to-interference plus noise ratio (L1-SINR).

22. The method of claim 18, wherein the at least one part of the CSI report includes a first part and a second part, the second part indicating at least one of an additional MPE value, a beam identifier (ID), or a panel ID.

23. The method of claim 22, wherein the at least one part includes a first part and a second part if at least one bit in the CSI report is set to a value of one (1).

24. The method of claim 22, wherein the additional MPE value is associated with at least one of the one or more uplink beams, the one or more downlink beams, or the one or more UE panels, wherein the additional MPE value corresponds to at least one bit in the CSI report.

25. The method of claim 24, wherein the additional MPE value includes at least one of a power management maximum power reduction (P-MPR) value, a virtual power headroom report (PHR) value, or an uplink reference signal received power (RSRP) corresponding to at least one of the one or more uplink beams, the one or more downlink beams, or the one or more UE panels.

26. The method of claim 22, wherein the CSI report indicates one or more alternative uplink (UL) beams or one or more alternative panels.

27. The method of claim 26, wherein the one or more alternative UL beams or the one or more alternative panels correspond to at least one of a synchronization signal block (SSB) resource indicator (SSBRI), a channel state information reference signal (CSI-RS) resource indicator (CRI), a sounding reference signal (SRS) ID, a panel ID, a closed loop index, or a SRS resource set ID.

28. The method of claim 18, wherein the CSI report includes one or more bits for each of the one or more UE panels, the one or more bits associated with one or more sets of reference signals (RS).

29. The method of claim 18, wherein the CSI report includes at least one bit indicating that the at least one MPE event corresponds to at least one of the one or more uplink beams, the one or more downlink beams, or the one or more UE panels.

30. An apparatus for wireless communication of a base station, comprising:
a memory; and
at least one processor coupled to the memory and configured to:
transmit, to a user equipment (UE), one or more downlink beams or receiving, from the UE, one or more uplink beams; and
receive, from the UE, a channel state information (CSI) report including at least one part associated with a maximum permissible exposure (MPE) event, the at least one part indicating at least one of the one or more uplink beams, the one or more downlink beams, or one or more UE panels.
